(19) United States
(12) Patent Application Publication
(10) Pub. No.: US 2007/0168085 A1
(43) Pub. Date: Jul. 19, 2007

(54) Systems and method for adaptively adjusting a control loop

(76) Inventor: John H. Guilford, Loveland, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/283,213

(22) Filed: Nov. 18, 2005

(51) Int. Cl. G01M 1/38; G05B 13/00

(52) U.S. Cl. 700/280

(57) ABSTRACT

A system and method for controlling output of a system component includes a control loop operable to measure the output and to adjust one or more operating characteristics of the system component in response thereto, the control loop including a plurality of parameters that define its performance and a loop controller unit operable to measure an error of the output and to adjust one or more of the parameters in response thereto.

### TECHNICAL FIELD

This application relates generally to closed loop control systems.

### BACKGROUND OF THE INVENTION

Closed loop control systems are a part of many industrial devices, precision instruments, and the like. In general, a closed loop control system, often called a “control loop,” measures a phenomenon (e.g., output of a circuit, mechanical motion, and the like) and then uses the results of the measurement to control a process that directly or indirectly produces the phenomenon. A textbook example is a steel rolling mill with a sensor that measures the thickness of a steel plate as it emerges from the rollers. The sensor feeds the measurement back to a controller that compares the measurement to a desired thickness value. The controller then sends control signals to the rollers to adjust the thickness, thereby keeping the steel plate within accepted production standards. Thus, if the controller ascertains that the thickness exceeds a set value, it adjusts the rollers to decrease the thickness. Cruise control on a car is another example of a control loop wherein a sensor measures the speed, and based upon the measured speed compared to the set speed, a controller either accelerates or decelerates the engine to maintain the set speed.

Typically, in both analog and digital electronic control systems, the control loop measures the error and processes it with a filter. The output of the filter is usually a control signal that is fed back to, e.g., actuators on the controlled component. The performance of the loop is generally determined by one or more filter settings. Speed of response of a filter is one particular performance characteristic of a control loop that is determined by the settings. Typically, when speed of response of the filter is increased, the control loop minimizes errors more quickly and is better able to correct larger errors. However, the increased speed of response comes at a cost of increased noise in the settled signal.

Accordingly, designers of control loops often trade speed for low-noise characteristics. In a given application, a designer may pick a value for speed of response that provides adequate speed and effectiveness in the range of expected error while producing an acceptable amount of output noise. However, neither the output noise nor the speed of response are optimized. The trade-off may make it difficult to design a fast control loop for a large error range in a precision application.

### BRIEF SUMMARY OF THE INVENTION

Various embodiments of the invention include dynamically adapting performance parameters (e.g., speed of response) of a control loop in response to a measured error of a system component. According to one embodiment of the invention, a system for controlling output of a system component includes a control loop operable to measure the output and to adjust one or more operating characteristics of the system component in response thereto. The control loop has a plurality of parameters that define its performance. The system further includes a loop controller unit operable to measure an error of the output and to adjust one or more of the parameters in response thereto.

According to another embodiment of the invention, a method for controlling an output of a system component includes providing a control loop to control operation of the system component. The method further includes measuring the operation of the system component and adjusting a performance characteristic of the control loop in response to the measuring.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is an illustration of an exemplary system for controlling output a of system component;

FIG. 2 is a high-level flowchart of an exemplary method for controlling the output of a system component adapted according to an embodiment of the invention;

FIG. 3 is a flowchart of an exemplary method, adapted according to an embodiment of the invention, that is performed when an exemplary system executes exemplary code; and

FIG. 4 illustrates an exemplary computer system adapted according to embodiments of the present invention.

### DETAILED DESCRIPTION OF THE INVENTION

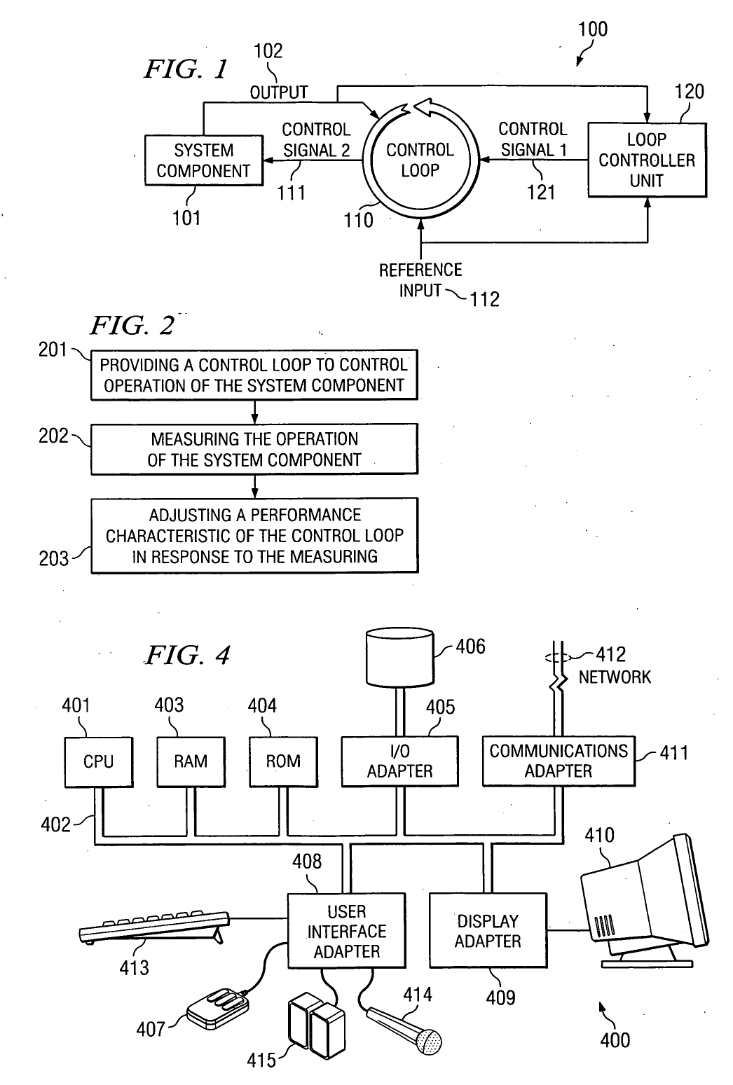

FIG. 1 is an illustration of exemplary system 100 for controlling output 102 of system component 101. System component 101 can be any kind of component that is controllable by control loop 110. For example, system component 101 may be a frequency oscillator wherein its output 102 is measured against reference 112 (in this example, a reference frequency) by control loop 110. Based on the measured error (e.g., the difference between output 102 and reference 112), control loop 110 changes the operating characteristics of system component 101 by sending control signals 111 to cause system component 101 to keep its output 102 closer to the ideal, expected output (e.g., closer to reference 112). In another example, system component 101 is a time-of-day clock, such that output 102 is a signal that represents a time of day. These examples are discussed in more detail below. Many other kinds of system components exist (e.g., mechanical system components, wherein output 102 is power, position, or the like) and are within the scope of various embodiments of the invention.

As control loop 110 controls system component 101, loop controller unit 120 adjusts one or more parameters of control loop 110, using control signal 121, to change the performance of control loop 110 in response to the measured error in output 102. Performance characteristics of loop 110 that are affected by the parameters include speed of response, bandwidth, overshoot, damping ratio, and the like. In this example, loop controller unit 120 observes the performance of control loop 110 by measuring the error of system component output 102. In system 100, loop controller unit 120 measures the error by comparing output 102 to reference 112, in a method similar to that performed by control loop 110. In another example, loop controller unit 120 receives an error measurement from control loop 110 or another source (not shown) or may simply calculate the error in a different way, such as calculating a time averaged error. Various embodiments of the invention are not limited in the ways in which loop controller unit 120 calculates error.

As explained earlier, there is a trade-off between speed of response and output noise in most control loops. In system 100, loop controller unit 120 adjusts the speed of response of control loop 110 by changing the bandwidth of control loop 110 based on measured error. Typically, increasing the bandwidth of the control loop increases the speed of response, while decreasing the bandwidth decreases the speed of response. Generally, if the measured error is small for a sufficiently long time, then loop controller unit 120 concludes that control loop 110 is converged (i.e., has brought the error down to a steady state level) and switches to a lower bandwidth in order to take advantage of a lower-noise result. However, if loop controller unit 120 detects that the error is large for a sufficiently long time, then it concludes that control loop 110 is not converged, and it increases the bandwidth of control loop 110 in order to speed up response and bring about reduction of output errors in a minimum amount of time. In short, loop controller unit 120 monitors the error of system component 101, and, based on the measured error, dynamically modifies the parameters (i.e., system settings that determine performance characteristics, such as bandwidth and the like.) of control loop 110. In this example, loop controller unit 120 performs its algorithm throughout operation of system 100, such that once convergence is achieved, loop controller unit 120 will adjust the bandwidth down accordingly, as described.

As explained above, an exemplary system includes an oscillator as system component 101. Specifically, system component 101 is an oscillator for a digitally tuned radio. In such a system, when a user changes a radio station, for example, to 90.5 MHz, control loop 110 receives the oscillator frequency via output 102 and divides it by, for example, 90.5. Control loop 110 then compares the divided signal against reference input 112, which in this example is a 1 MHz reference clock. Because the user is changing the station, the oscillator frequency will reflect the previous setting rather than the desired setting, and as a result, control loop 110 will detect an error. Thus, instead of the divided frequency being 1 MHz, the divided frequency may be 0.997 MHz. Control loop 110 detects the error and uses control signal 111 to cause system component 101 to increase its frequency. Control loop 110 operates to decrease the error iteratively or continuously until loop 110 is converged.

According to embodiments of the present invention, as loop 110 operates to decrease the error and tune the oscillator, loop controller unit 120 also measures the error, and, if appropriate, changes parameters of loop 110 in response. In this example, there are various error thresholds that may be predefined or calculated according to one or more other algorithms. One or more thresholds define an error as “high,” while one or more other thresholds may define an error as “low.” If loop controller unit 120 determines that the error has been high for a certain amount of time, it increases the speed of response of loop 110, by, for example, adjusting parameters that determine bandwidth. On the other hand, if loop controller unit 120 determines that the error has been low for a certain amount of time, it decreases the bandwidth of loop 110 to lower noise. Thus, loop controller unit 120 is operable to dynamically tune the parameters of control loop 110 in order to obtain higher speed of response when desired for adjusting the operation of component 101 quickly and to reduce noise when so desired. In other words, loop controller unit 120 dynamically tunes parameters of loop 110 to provide balance in the conflict between speed and noise.

In yet another example, system component 101 is a time-of-day clock. In most precision clocks, there is an oscillator that is set to a desired frequency; however, various phenomena may influence the performance of the oscillator, such as ambient temperature fluctuations, power fluctuations, and the like. Accordingly, it may be desirable to check such clocks for error, and if necessary, adjust the internal oscillators using control loop 110. In this example, reference input 112 may be a Global Positioning System (GPS) time reference or an IEEE 1588 protocol reference. Control loop 110 compares output 102 to reference 112 to determine an error, and, if appropriate, adjusts the oscillator in component 101 to speed the clock up or slow the clock down. As loop 110 operates to minimize the error, loop controller unit 120 measures the error. Similar to the example above, loop controller unit 120 adjusts parameters of loop 110 based on the measured performance of system component 101, to, for example, increase or decrease speed of response.

FIG. 2 is a high-level flowchart of exemplary method 200 for controlling the output of a system component adapted according to an embodiment of the invention. In step 201, a control loop is provided to control operation of the system component. The invention is not limited by type of control loop, as it can include any kind of feedback loop system that is operable to provide control for the system component. In some embodiments, the control loop includes a digital or analog filter that is operable to produce control signal output as it receives error input. The filter acts to reduce the error and hold the output to an acceptable range once the loop is converged.

In step 202, a loop controller unit or the control loop measures the operation of the system component. The operation of the system component can be measured in any of a number of ways, including for example, measuring an error of an output of the system component, measuring a non-output internal signal in the component, and the like. In one example, the control loop measures the error of the output of the system component and sends the error signal to the loop controller unit. In another example, the loop controller unit calculates error on its own. Any way of measuring operation of the system component is within the scope of various embodiments of the invention.

In step 203, the loop controller unit adjusts a performance characteristic of the control loop in response to the measuring. It should be noted that measuring the performance of the system component serves as an indirect measure of the operation of the control loop. The loop controller unit operates to compare the error to various criteria (e.g., threshold levels) and to determine if the control loop is converging or has converged. An error that is high for a period of time may indicate that the control loop is operating slowly or ineffectively. Accordingly, the loop controller unit may increase the speed of response. Alternatively, an error that is low for a period of time may indicate that convergence is achieved. Accordingly, the loop controller unit may decrease the speed of response of the control loop in order to take advantage of a lower-noise output.

In many embodiments, the control loop includes a digital or analog filter that serves as its main functional unit in the feedback path. In those examples, adjusting a performance characteristic of the control loop usually includes sending control signals that change loop parameters, such as coefficients (in the case of a digital filter) or component values (in the case of an analog filter). Some more elaborate and larger filters may include, for example, fifty or more coefficients or component values, and in those cases, adjusting a performance characteristic may include changing many filter parameters. The invention is not limited by filter size.

In one example, the loop controller unit includes a plurality of defined sets of loop parameters with corresponding bandwidth levels, providing discrete performance settings for the control loop. In this case, adjusting the performance characteristic of the control loop includes changing the bandwidth to the next level, up or down. Alternatively, the loop controller unit may employ a continuous range of loop parameters, thereby providing more narrowly tailored adjustments to the performance of the control loop. In fact, in some embodiments, intelligence may be included in the loop controller unit to calculate optimal performance characteristics using heuristics or algorithmic techniques.

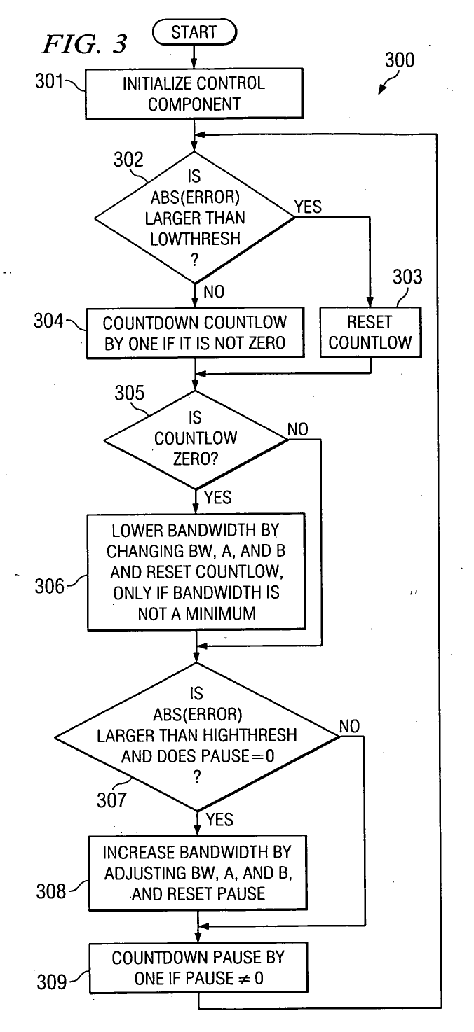

Method 200 may be performed by a computer program executing instructions that are approximated by the following pseudo code. In the following example, the loop controller unit compares the measured error to a high threshold and to a low threshold, and, if appropriate, applies a set of parameters to the control loop to define a higher or lower discrete bandwidth setting. A more detailed explanation of the pseudo code is provided in the discussion of FIG. 3.

First, values are initialized:
A_LIST[0:3]={10.0, 3.0, 1.0, 0.3} (coefficient values that each correspond to one of four bandwidth levels)
B_LIST[0:3]={0.6, 0.05, 0.006, 0.006} (coefficient values each that correspond to one of four bandwidth levels)
LOWTHRESH=10 (a lower threshold)
HIGHTHRESH=20 (a higher threshold)
TC=32 (a time constant that is used to reset PAUSE and CNTLOW variables, thereby determining the minimum amount of time between bandwidth adjustments)
BW=0 (an index indicating a particular bandwidth level)
A=A_LIST[BW] (one of the A_LIST values)
B=B_LIST[BW] (one of the A_LIST values)
PAUSE=0
CNTLOW=TC
INTEG_ERROR=0 (integral of the error)

After initialization, the program performs the following algorithm when it receives a new error value. ERROR is the measured error value; RATE is the variable that the control loop applies to the system component. A and B are parameters that define performance characteristics of the control loop, and, in this case, affect the bandwidth and speed of response of the control loop.
INTEG_ERROR=INTEG_ERROR+ERROR
RATE=B* INTEG_ERROR+A* ERROR (The expression to the right of the equal sign is a Proportional Integral (PI) expression for the control loop.)

The following pseudo code operates to countdown the CNTLOW variable when the error is not larger than a lower threshold. When CNTLOW is zero, the program decreases the bandwidth to a next lower setting by changing values of A and B.

```
If (abs(ERROR) > LOWTHRESHOLD)
  CNTLOW = TC
Else if (CNTLOW > 0)
  CNTLOW = CNTLOW − 1
If (CNTLOW = 0)
if (BW < 3)
  BW = BW + 1
  A = A_LIST[BW]
  B = B_LIST[BW]
CNTLOW = TC
```

The following pseudo code operates to countdown the PAUSE variable and to increase the bandwidth of the control loop when PAUSE equals zero and the error is above a higher threshold. It should be noted that PAUSE causes the system to wait before adjusting the A and B parameters, as described further below.

```
If (abs(ERROR) > HIGHTHRESH and PAUSE = 0)
  if (BW > 0 )
    BW = BW − 1
    A = A_LIST[BW]
    B = B_LIST[BW]
  PAUSE = TC
IF (PAUSE > 0)
  PAUSE = PAUSE − 1
```

Accordingly, the program waits until PAUSE or CNTLOW have been counted down to zero before changing a bandwidth setting. Such a feature forces the program to give the control loop a chance, after a bandwidth change, to reach steady state and operate at the bandwidth setting for at least a short amount of time before making another bandwidth change. Otherwise, the control loop at any given setting may not have an opportunity to provide adequate results, and such systems tend to progress almost immediately to the highest bandwidth setting upon detecting an output transient.

FIG. 3 is a flowchart of exemplary method 300, adapted according to an embodiment of the invention, that is performed when an exemplary system executes instructions based on the pseudo code above. In step 301, the system initializes the loop controller unit, including assigning values to the variables and constants that are used in the program.

In step 302, the system ascertains if the absolute value of ERROR is larger than a lower threshold. If the answer is yes, then the system resets the value of CNTLOW to its maximum value at step 303. If the answer is no, then the system counts down CNTLOW by one if CNTLOW is larger than zero at step 304. In this example, CNTLOW is a value that is used to cause the system to wait a prescribed amount of time before adjusting the bandwidth setting lower.

Next, the system ascertains if CNTLOW is equal to zero at step 305. If CNTLOW is not equal to zero, the system progresses to step 307. If CNTLOW is equal to zero, and if the bandwidth of the control loop is not at its lowest setting, then the system lowers the bandwidth setting of the control loop by changing the values for BW, A, and B at step 306. The system also resets the value of CNTLOW at step 306. As shown above in the pseudo code, the new value of the BW index selects values for A and B, and the new values for A and B affect the bandwidth of the loop. The RATE value is then applied to the system component (e.g., a clock) to adjust is response. It should be noted that a higher value for BW corresponds to a lower bandwidth setting in this example.

In step 307, the system ascertains if the absolute value of ERROR is larger than a higher threshold and if PAUSE equals zero. If one or both are not true, then the system skips to step 309. If both are true and if the control loop bandwidth is not at a maximum, then the system increases the control loop bandwidth by changing the values for BW, A and B at step 308. Also at step 308, the system resets the PAUSE variable. At step 309, the system counts down the PAUSE variable and skips up to step 302.

Thus, according to FIG. 3, the example system includes a discrete number of parameters that correspond to bandwidth levels to affect a speed of response of the control loop, and the system moves up or down one bandwidth level at a time in response to the measured error. Further, the system waits a prescribed amount of time between bandwidth level changes. The system repeats method 300 to keep the performance of the control loop in an acceptable range.

In prior art systems, designers often have to pick static values for the loop parameters, thereby effectively choosing a single value for speed of response for a control loop; however, the speed of response value is usually not optimal for either converging or for providing a low-noise result once convergence is achieved. An advantage of some embodiments of the invention is that a system designer may use a plurality of discrete loop parameters or a range of loop parameters, such that some corresponding response speeds are better suited for converging the control loop, while other values are better suited to providing a low-noise result. Such embodiments adaptively provide loop parameters to the control loop during operation to optimize performance of the control loop. Thus, various embodiments combine the quick convergence of a high bandwidth control loop with the low noise of a low bandwidth control loop.

The examples above describe that loop parameters affect speed of response and bandwidth of the loop. However, the parameters also affect the other performance characteristics, including, but not limited to, overshoot, steady state error, and damping ratio. Thus, while emphasis in these examples is on speed of response and bandwidth, other embodiments may use loop parameters in order to affect other performance characteristics.

Further, any feedback controller may benefit from various embodiments of the invention if it has performance characteristics that may be adjusted or if it may be modified to allow adjustment of performance characteristics. Examples of other kinds of control loops that may benefit from one or more embodiments include industrial controllers, automatic navigation systems, thermostats, servo motor controllers, and the like. Additionally, while the functional units in FIG. 1 are shown as connected directly to each other, in various embodiments, one or more functional units may be connected to each other or to outside units (not shown) via a network, such as the Internet, a Local Area Network (LAN), Wide Area Network (WAN), or the like.

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 4 illustrates an example computer system 400 adapted according to embodiments of the present invention. That is, computer system 400 comprises an example system on which embodiments of the present invention may be implemented (such as control loop 110 and/or loop controller unit 120 of FIG. 1). Central processing unit (CPU) 401 is coupled to system bus 402. CPU 401 may be any general purpose CPU. However, the present invention is not restricted by the architecture of CPU 401 as long as CPU 401 supports the inventive operations as described herein. CPU 401 may execute the various logical instructions according to embodiments of the present invention. For example, CPU 401 may execute machine-level instructions according to the exemplary operational flows described above in conjunction with FIGS. 2 and 3.

Computer system 400 also preferably includes random access memory (RAM) 403, which may be SRAM, DRAM, SDRAM, or the like. Computer system 400 preferably includes read-only memory (ROM) 404 which may be PROM, EPROM, EEPROM, or the like. RAM 403 and ROM 404 hold user and system data and programs, as is well known in the art.

Computer system 400 also preferably includes input/output (I/O) adapter 405, communications adapter 411, user interface adapter 408, and display adapter 409. I/O adapter 405, user interface adapter 408, and/or communications adapter 411 may, in certain embodiments, enable a user to interact with computer system 400 in order to input information, such as start commands to any of the functional units of FIG. 1.

I/O adapter 405 preferably connects to storage device(s) 406, such as one or more of hard drive, compact disc (CD) drive, floppy disk drive, tape drive, etc. to computer system 400. The storage devices may be utilized, for example, to store instructions indefinitely. Communications adapter 411 is preferably adapted to couple computer system 400 to network 412. User interface adapter 408 couples user input devices, such as keyboard 413, pointing device 407, and microphone 414 and/or output devices, such as speaker(s) 415 to computer system 400. Display adapter 409 is driven by CPU 401 to control the display on display device 410 to, for example, display s user interface in some embodiments of the present invention.

It shall be appreciated that the present invention is not limited to the architecture of system 400. For example, any suitable processor-based device may be utilized, including without limitation personal computers, laptop computers, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for controlling output of a system component, the system comprising:
a control loop operable to measure said output and to adjust one or more operating characteristics of said system component in response thereto, said control loop including a plurality of parameters that define performance of said control loop;
a loop controller unit operable to measure an error of said output and to adjust one or more of said parameters in response thereto.

2. The system of claim 1 wherein said plurality of parameters define one or more of:
a bandwidth of said control loop;
an overshoot of said control loop;
a damping ratio of said control loop;
a noise of said control loop; and
a speed of response of said control loop.

3. The system of claim 2 wherein said loop controller unit is operable to perform the following functions by adjusting said parameters:
decreasing said bandwidth in response to said error being below a low threshold; and
increasing said bandwidth, thereby increasing said speed of response of said control loop, in response to said error being above a high threshold.

4. The system of claim 1 wherein said parameters include one or more coefficients entered into a digital filter in said control loop.

5. The system of claim 1 wherein said parameters include one or more component values applied to an analog filter in said control loop.

6. The system of claim 1 wherein said loop controller unit is operable to adjust said parameters by selecting a setting from a plurality of settings, each said setting corresponding to a discrete bandwidth level.

7. The system of claim 1 wherein said loop controller unit is operable to adjust said parameters after a predefined amount of time has passed since a previous adjustment.

8. The system of claim 1 wherein said system component is a clock.

9. The system of claim 1 wherein said error of said output is a difference between said output and a reference input to said control loop.

10. A method for controlling an output of a system component, said method comprising:
providing a control loop to control operation of said system component;
measuring said operation of said system component; and
adjusting a performance characteristic of said control loop in response to said measuring.

11. The method of claim 10 wherein measuring said performance of said system component includes calculating an error equal to a difference between a reference value and a value of said output.

12. The method of claim 11 wherein said error is a time average of a difference between a reference value and a value of said output.

13. The method of claim 11 wherein said performance characteristic of said control loop includes a bandwidth of said control loop.

14. The method of claim 13 wherein adjusting said performance characteristic of said control loop comprises:
decreasing said bandwidth in response to said error being below a first threshold; and
increasing said bandwidth in response to said error being above a second threshold.

15. The method of claim 13 further comprising:
defining a plurality of bandwidth levels, wherein adjusting said performance characteristic includes sending control signals to said control loop, thereby causing said control loop to operate at one or more of said bandwidth levels.

16. The method of claim 13 wherein said adjusting said performance characteristic of said control loop includes sending control signals to said control loop, thereby causing said control loop to operate within a continuous range of bandwidth levels.

17. A system for controlling an output of a system component, said method comprising:
means for controlling an operation of said system component by minimizing an error of said output; and
means for adjusting a speed of response of said means for controlling in response to said error.

18. The system of claim 17 wherein said means for adjusting a speed of response is operable to change said speed of response by applying one or more loop parameters to said means for controlling, said one or more loop parameters determining a bandwidth of said means for controlling.

19. The system of claim 17 wherein said means for adjusting said speed of response applies one or more discrete sets of loop parameters to said means for controlling.

20. The system of claim 17 wherein said means for controlling includes one or more of:
a digital filter that receives said output and a reference input and outputs control signals to said system component based thereon; and
an analog filter that receives said output and said reference input and outputs control signals to said system component based thereon.
